(19) United States
(12) Patent Application Publication
(10) Pub. No.: US 2004/0017906 A1
(43) Pub. Date: Jan. 29, 2004

(54) Method of disconnecting a computer modem or other telephone enabled system from a telephone line to prevent unauthorized calls

(75) Inventor: Thomas M. Stephany, Churchville, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/202,336

(22) Filed: Jul. 24, 2002

(51) Int. Cl. H04M 3/00

(52) U.S. Cl. 379/188

(57) ABSTRACT

A computer system that prevents unauthorized connection to an undesired telephone number by disconnecting the telephone modem from the telephone line, the computer system includes an operating system for executing a startup routine that connects to a web site; a first mechanism for receiving a command from a web site to take unauthorized control of the telephone modem; and a second mechanism for denying connection to an unauthorized telephone number.

### FIELD OF THE INVENTION

The invention relates generally to the field of computers computer modems and, more particularly, to security features implemented during use of such computers and computer modems during internet browsing.

### BACKGROUND OF THE INVENTION

The proliferation of the internet and it's various uses is well known to a large percentage of the general populace. The multiplicity of websites on the internet provide a plurality of places to gather information, download items of interest, or just chat with other users. Most of these sites must pay some ISP (Internet Service Provider) a fee schedule of some kind that provides server space for the particular site and access to the internet. While some entities pay these fees personally, some expect to realize a return of those fees or even a profit. Thus advertising banners and visitor links directing internet users to other web-sites are utilized for the purpose of collecting fees. These fees are paid for connections from web-site one to web-site two for an internet user that uses the link provided by web-site one. Web-sites thereby provide fees to other web sites based upon the use of these links.

Another more insidious side of the internet is that other fees can be realized if people call 900 telephone numbers or long distance and international numbers for various purposes. Certain web-sites can and do direct telephone line connected modems to do just that. During this process, a plurality of spam and advertising banners are being sent to the internet browser being used for the purpose of confusing the internet user while the unauthorized number is dialed. These illegal and unauthorized calls can be accomplished in any of a number of ways including Active-X controls or simple executable Trojans or viruses to control the computer modem. Presently, if the internet user is fast enough, the only remedy is to power down the computer before the unauthorized call is completed. This type of shutdown risks damage to the computer and is rarely fast enough to guarantee the prevention of an unauthorized connection.

While illegal, these unauthorized calls leave no alternative to an internet user other than to be very careful and watch their telephone bills to make sure that such calls have not been made.

Consequently, a need exists to prevent such unauthorized calls by giving a user of the internet an ability to prevent such calls from being completed.

### SUMMARY OF THE INVENTION

The present invention provides a solution. In this regard, when an internet user is audibly alerted by the DTMF tones emitted by the telephone modem during an unauthorized dialing sequence, a simple modem disconnect switch enables a user to rapidly remove the telephone modem from the telephone line before an unauthorized call can be completed. Alternatively, this could also be accomplished in software being used as a traffic cop that will intercept the modem access commands controlled by the above mentioned control programs and prompt the user that a modem use command has been received and ask the user if this command can be executed. This provides greatly enhanced computer and internet security which presently does not exist.

In the prior art, while it is possible to add currently available software and hardware firewall protections, virus programs, and using the highest security settings in a users internet browser, this does not guarantee a prevention of malicious use of the computer at any one point in time.

The present invention is directed to overcoming one or more of the problems set forth above. Briefly summarized, according to one aspect of the present invention, the invention resides in a computer system that prevents unauthorized connection to an undesired telephone number by disconnecting the telephone modem from the telephone line, the computer system comprising (a) an operating system for executing a startup routine that connects to a web site; (b) a first mechanism for receiving a command from a web site to take unauthorized control of the telephone modem; and (c) a second mechanism for denying connection to an unauthorized telephone number.

The above and other objects of the present invention will become more apparent when taken in conjunction with the following description and drawings wherein identical reference numerals have been used, where possible, to designate identical elements that are common to the figures.

### ADVANTAGEOUS EFFECT OF THE INVENTION

The present invention has the following advantage of preventing unauthorized telephone calls from being completed from unauthorized commands by giving a user of the internet an ability to prevent such calls from being completed.

### BRIEF DESCRIPTION OF THE DRAWINGS

FIG. 1 is a perspective view with a portion cutaway of a computer of the present invention showing an internal telephone modem connected to a telephone line, and a dashed line area indicating the capability of preventing unauthorized calls by said computer modem;

FIG. 2 is a perspective view of one possible hardware solution of the present invention; and

FIG. 3 is a software flow-chart detailing on possible software solution of the present invention.

### DETAILED DESCRIPTION OF THE INVENTION

In the following description, the present invention will be described in the preferred embodiment as a hardware and a software program. Those skilled in the art will readily recognize that the equivalent of such software and hardware combinations may vary in a number of ways.

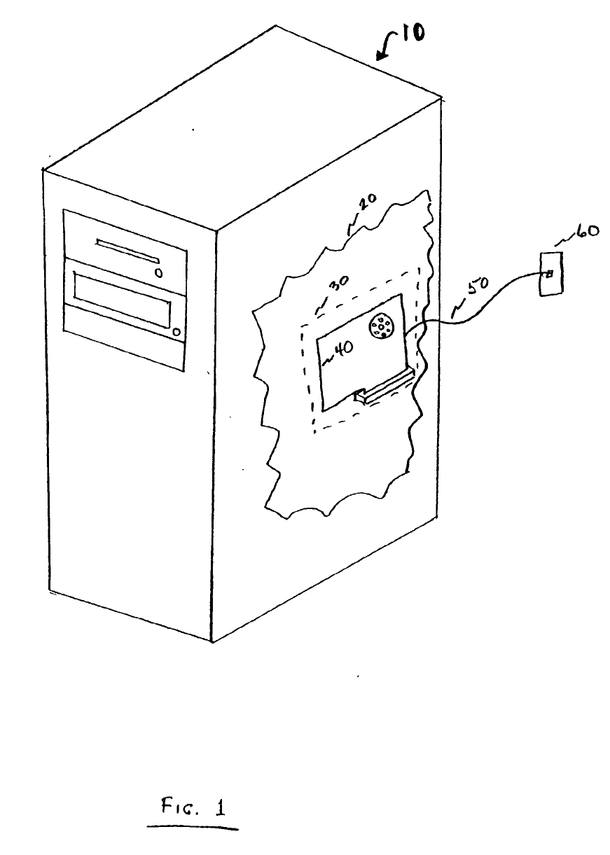

Referring to FIG. 1, shown is a computer system 10, with a cut-away portion 20, which details a dashed portion 30, surrounding an internal analog modem 40, connected to an analog telephone cord 50. Telephone cord 50, which attaches to a standard telephone wall jack 60, is the connection method for a vast number of computer users. Connection to a personal ISP or Internet Service Provider is necessary to establish a connection to the internet. Dashed portion 30, which indicates for purposes of clarity, the area of computer system 10 which is in need of further protection by methods of the present invention utilizing software, hardware or combinations of both. When computer users connect to sites upon the internet through their ISP, the dashed potion 30, including the analog modem 40 can become vulnerable to manipulation by unscrupulous individuals which attempt to make money through the illegal re-direction of a connection to a pay for use site such as a 900 number or even an international number. Since 900 numbers can charge multiple dollars per minute of connection, the re-direction of a call is profitable to the re-director if the re-direction of the connection is not caught by the user, and the billing of resulting charges challenged to the users phone company. The re-direction is accomplished by sending a program to the user computer, which directs the modem to disconnect from the users ISP. The program then directs the redial of the modem to connect to another number such as the aforementioned 900 or international number.

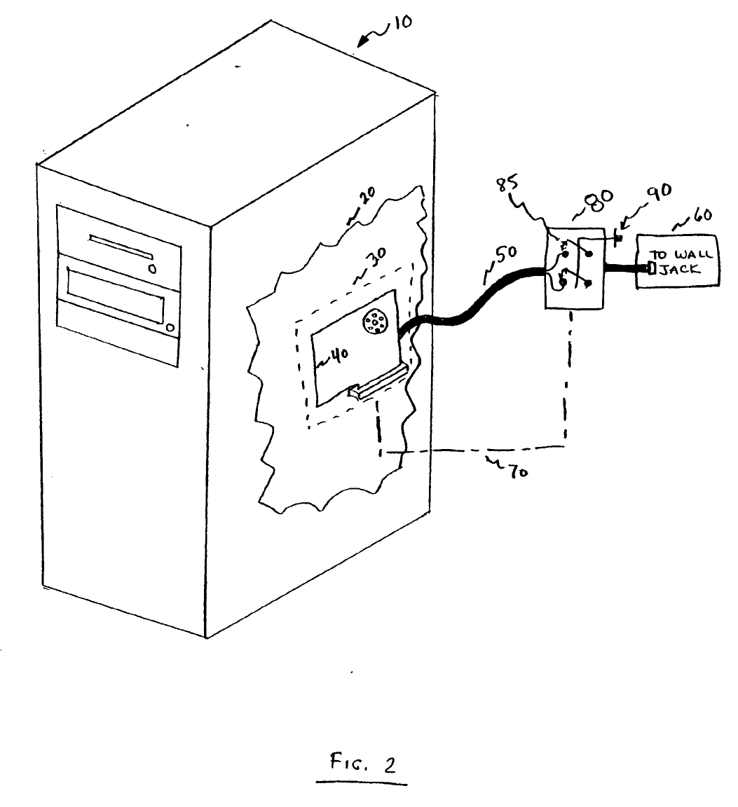

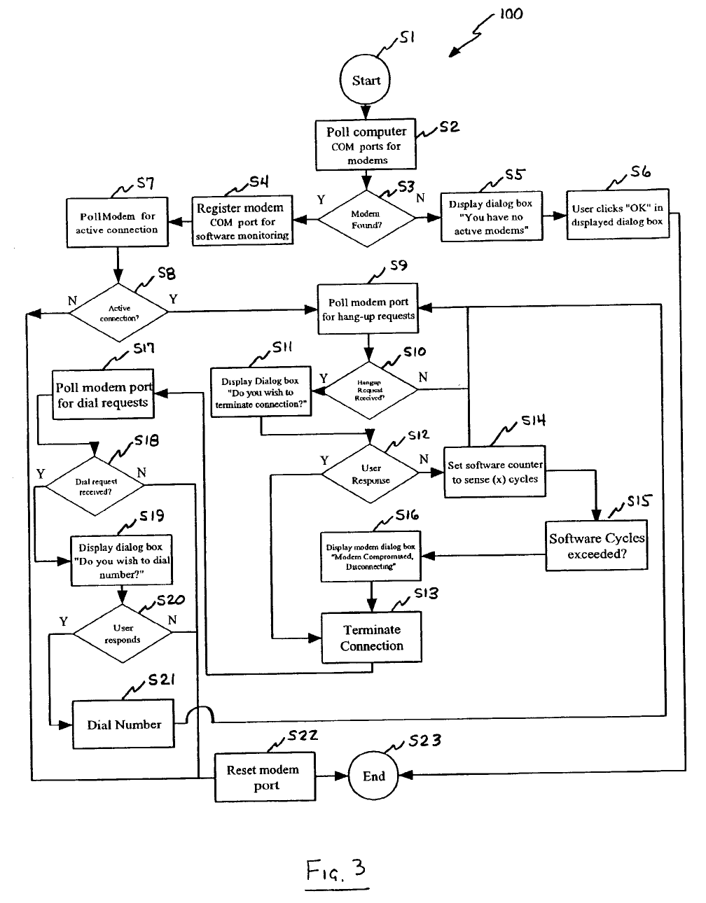

Referring next to FIG. 2, the computer system 10, with cut away portion 20 shows by virtue of connection line 70 a hardware implementation of a solution to the problem detailed above. Box 80 which is connected between computer modem 40 and wall jack 60 contains a plurality of disconnect contacts 85 which are activated by a manual disconnect switch 90 for the purpose of disconnecting computer system 10 and modem 40 from the telephone line. A user, upon hearing the modem redialing, simply reaches over and manually disconnects the modem 40 from the telephone jack 60 thus preventing any unauthorized connection. Connection line 70 also inherently implies that the manual disconnect switch 90 can be electrically disconnected by control software which will be detailed in FIG. 3.

Referring now to FIG. 3, a software flowchart detailing the operation of software program 100 is shown for disclosing one of any number of possible software solutions of the present invention. When the computer system 10 is started, software 100 is loaded into memory (manually or automatically) for the express purpose of monitoring the activity of the computer modem 40 and its operating status after an initial connection to a users ISP is established. At the start of the program S1, the software program 100 polls the computer Com ports, S2 for existing computer modems 40 and its unique Com port location. If a modem is found, S3, the unique Com port is registered S4 within the software for activity monitoring of that Com port. If no computer modem is found S3, a dialog box is displayed to the user stating that “You have no active modems on this computer”, S5. This being the case the user simply clicks “OK” in the displayed dialog box S6, and the software program 100 ends S23. Referring back to where the found modem is registered by the software S4, the modem is next polled for an active connection S7. If there is no active connection S8, the software program 100 resets the modem port S22, and then ends S23. If an active connection is found S8, the modem 40, is actively polled S9, for undesirable requests to disconnect and terminate ISP connection. When a hang up request is received S10, a dialog box is displayed “Do you wish to terminate connection?” S11. A user response of Yes at S12 results in a termination of connection S13. A user response of No at S12 initiates a software counter S14, whose purpose is to count a pre-determined amount of No answers. If the pre-determined amount of No answers is not exceeded S14, the software flow is re-directed to S9 where the modem is again polled for hang up requests. If another hang up request is received S10, a dialog box is again displayed “Do you wish to terminate connection S11. Again, a user response of No at S12 activates another count at software counter S14. This cycle is repeated until the software counter S14 exceeds its pre-determined count that then initiates software cycles exceeded S15. The purpose of this routine is to alert the modem 40 user that hang-up commands, not initiated by the user, are being repeatedly received. At this point a dialog box S16 would be displayed to the user that “Modem is compromised, Disconnecting”, and the ISP connection would be terminated S13. At this point in time the software program 100, not knowing if the user or a rogue program had requested the hang up request at S10, the modem port would be immediately polled for a dial request S17. If a dial request is received S18, a dialog box would be displayed asking “Do you wish to dial number”, S19. If no dial request is received at S18 the modem port is reset S22 and the software program 100 ends S23 for another session, as there is no rouge modem control being attempted. If the user responds with a Yes at S20, the number is dialed S21, and the software counter S14 is reset and the function is redirected to poll for hang up requests S9. Alternatively, if the users answer is No at S20, the modem port is reset for another session S22, and the software program 100 ends S23.

It should be noted at this point that that the software program 100 has been utilized to both prevent unauthorized calls from being made, and additionally to determine that a previously unidentified rogue program exists on the users computer 10. Software program 100, after identifying that a rogue control program exists, returns control to the user, who ultimately has responsibility to identify and remove the offending program. This can be done with a number of commercially available programs such as virus checkers and trojan sniffers.

The invention has been described with reference to a preferred embodiment. However, it will be appreciated that variations and modifications can be effected by a person of ordinary skill in the art without departing from the scope of the invention.

### PARTS LIST

| | |
|---|---|
| 10 | computer system |
| 20 | cut away portion |
| 30 | dashed portion |
| 40 | analog modem |
| 50 | telephone cord |
| 60 | wall jack |
| 70 | connection line |
| 80 | box |
| 85 | disconnect contacts |
| 90 | disconnect switch |
| 100 | software program |
| S1-S23 | software program steps |

What is claimed is:

1. A computer system that prevents unauthorized connection to an undesired telephone number by disconnecting the telephone modem from the telephone line, the computer system comprising:
(a) an operating system for executing a startup routine that connects to a web site;
(b) a first mechanism for receiving a command from a web site to take unauthorized control of the telephone modem; and
(c) a second mechanism for denying connection to an unauthorized telephone number.

2. A computer system as in claim 1, wherein the second mechanism is a mechanical disconnect switch.

3. The computer system as in claim 1, wherein the second mechanism is an electronic disconnect switch.

4. The computer system as in claim 1, wherein the second mechanism is a software program.

5. A method for preventing unauthorized access to a telephone modem that is executing a startup routine for connecting to a web site, the method comprising the steps of:
(a) receiving an unauthorized instruction from a web site which requests control of the telephone modem for dialing a number; and
(b) denying unauthorized access to the telephone modem by disconnecting the telephone modem by either automated or manual mechanisms.
